(19) United States
(12) Patent Application Publication
(10) Pub. No.: US 2011/0083543 A1
(43) Pub. Date: Apr. 14, 2011

(54) FOOT-OPERATED ACOUSTIC-MECHANICAL HAND-CLAPPING SOUNDING DEVICE

(76) Inventor: Gary Richard Peterson, Troy, MI (US)

(21) Appl. No.: 12/575,601

(22) Filed: Oct. 8, 2009

(51) Int. Cl. G10D 13/02

(52) U.S. Cl. 84/422.3

(57) ABSTRACT

This clapping sound device is a two-part musical percussion instrument—a sound box and a swiveling wood blocks assembly—that attaches to a typical hi-hat stand in place of the cymbals and produces a sound pattern similar to people clapping hands when the array of swinging blocks is activated by the foot pedal of the hi-hat apparatus causing the blocks to strike the stationary sound box in a slightly staggered sequence before the spring mechanism returns it to the ready position for further rhythmic impulses from the operator.

### SUMMARY OF INVENTION

The clapping sound device is an acoustic-mechanical musical instrument that emulates the sound pattern of a group of people clapping hands.

The two-part device attaches to a common hi-hat stand (sans cymbals) which is a vertical support tube with coaxial operating rod that extends above the tube and is pushed down and up by means of a foot pedal. The shallow sound box rests on the support tube and a horizontal array of striking blocks fasten perpendicularly to the operating rod. The blocks, separated by nylon spacers, are loosely retained on a single axle by a stop nut on either end so that the blocks can swivel freely. A central drive block couples the entire in-line block assembly to the operating rod at a point an inch or two above the sound box. A guidepost on the box keeps the blocks aligned as they travel downward on impulse from the foot pedal causing them to strike the sound box in a slightly staggered sequence.

Because the horizontal axle rod doesn't itself rotate, the rotation of each striking block on it can be limited and adjusted—by means of a set-screw post and a small counterweight—for timing the unsynchronized contact of each block to the sound box which amplifies the sound. It is a convenient and practical method to create a complex sound effect thru the simple activation of a single foot pedal by one musician.

### BRIEF DESCRIPTION OF DRAWINGS:

FIG. 1 is an isometric overview of the entire device (minus the floor stand and foot pedal).

FIG. 2 is an isometric section view thru the center from front to back showing the coupling of the sounding device to the reciprocating “hi-hat” mechanism.

FIG. 3 is an isometric section view thru a typical movable striking block.

FIG. 3A is a detail of the swiveling mechanism of a striking block.

FIG. 4 is a schematic top view of the device (excluding the hi-hat mechanism).

FIG. 5 is a schematic front view of the device (excluding the hi-hat mechanism).

FIG. 6 is a schematic cross-section view thru the center, perpendicular to the swivel axis and includes the reciprocating “hi-hat” mechanism.

FIG. 7 is a schematic side view.

### DRAWING NOTES

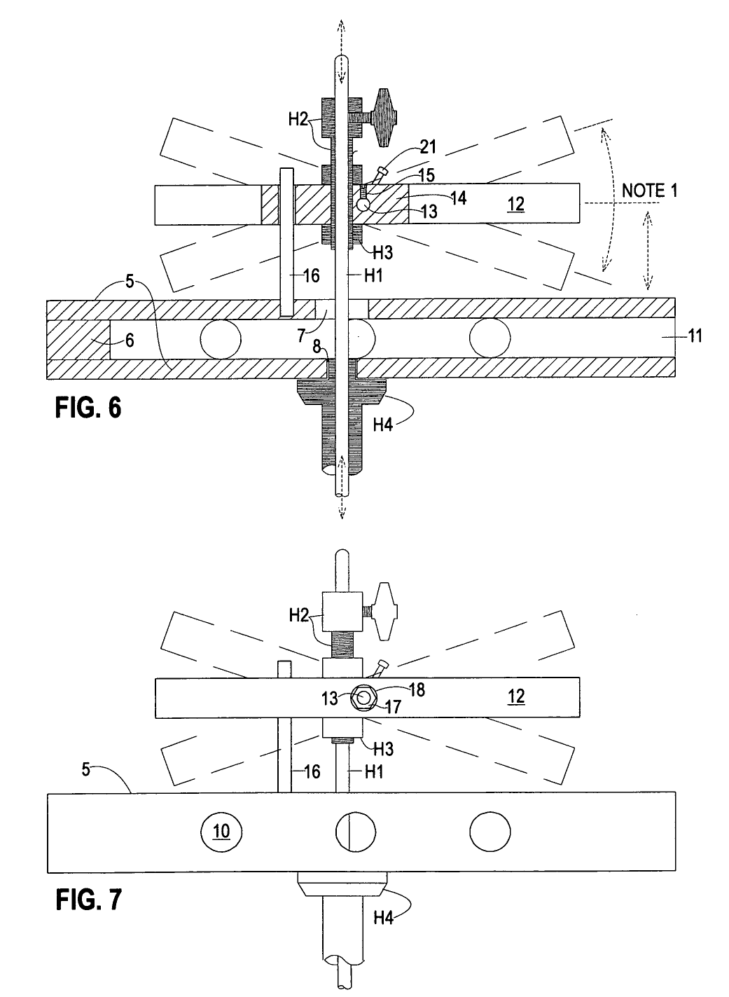

Note 1 Dashed lines indicate the swiveling and vertical extension ranges of the swing block assembly above sound box top surface. (FIG. 6)

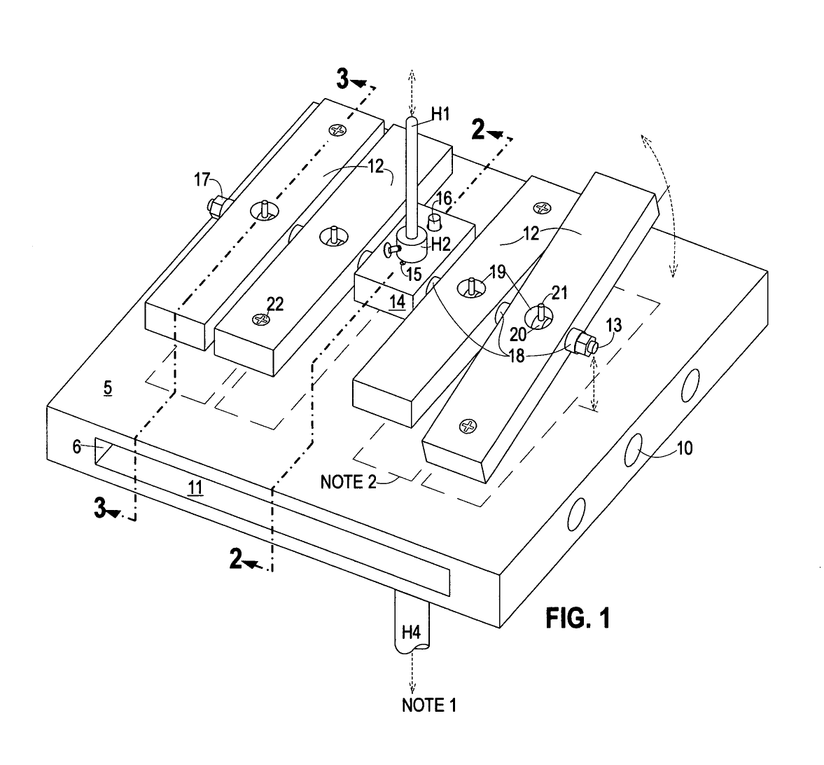

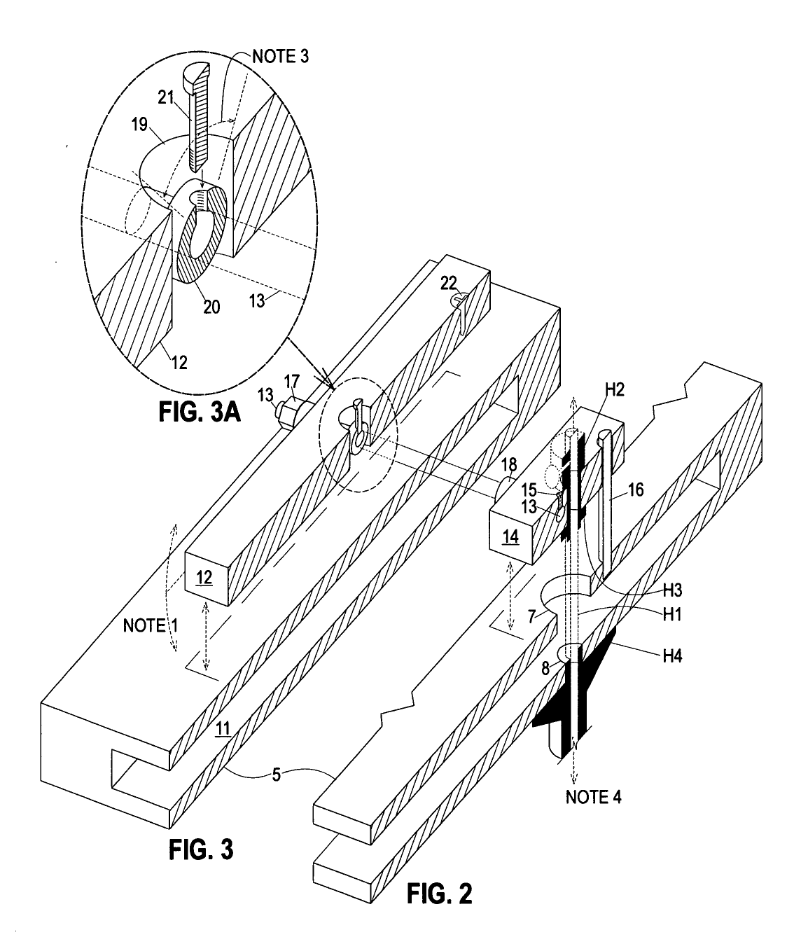

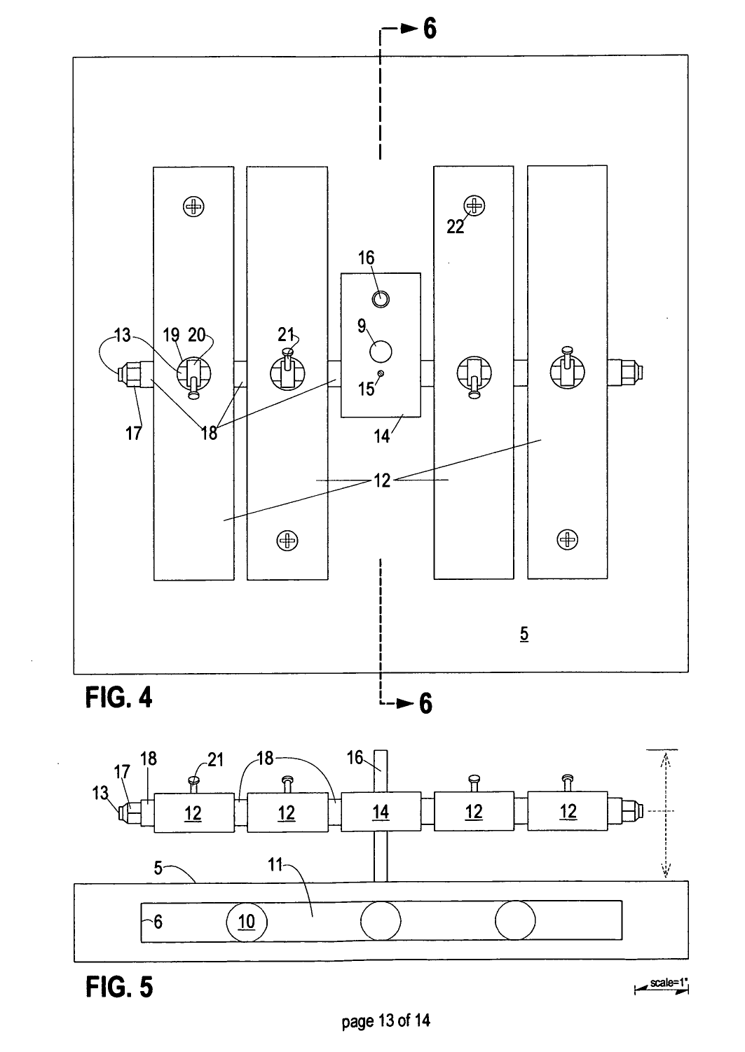

Note 2—Dashed line indicates “closed” position of blocks. (FIGS. 1 and 3)

Note 3—Adjustable range of screw posts 21 that limit the rotation of the swing blocks. (FIG. 3A)

Note 4—Spring-loaded foot pedal not shown. (FIG. 1)

### PARTS LEGEND

H1—operating rod
H2—clutch fastener
H3—retaining nut
H4—support tube
5—sound box
6—edge blocking
7—top plate hole
8—bottom plate hole
9—connector hole
10—sound hole
11—air cavity
12—striking block
13—axle rod
14—drive block
15—set screw
16—guide post
17—end nut
18—nylon spacers
19—access hole
20—bushing
21—screw post
22—counterweight

### DESCRIPTION OF PREFERRED EMBODIMENT

The structure of the clapping sound device is explained here with reference to the drawings. The device is used in conjunction with an existing or readily obtainable apparatus commonly known as a “hi-hat” cymbal stand that is normally a pair of cymbals, including a support for a stationary lower cymbal and a vertically slide-able coaxial operating rod H1 for a cooperating movable upper cymbal. A spring returns the movable cymbal off the stationary one. A foot pedal operates the movable cymbal against the stationary cymbal. In these drawings, any part of the hi-hat stand will be designated with the prefix “H” in front of its numeral symbol. The spring-loaded foot pedal that moves the operating rod up and down is understood and not illustrated.

The new clapping sound device attachment embodies two parts: the stationary sound box 5 including a guide post 16, and an upper assembly of swing blocks 12 on a horizontal axle 13 in FIG. 5. These two components replace the two cymbals commonly attached to a hi-hat stand. Cymbals are not used.

The shallow wooden sound box 5 in FIG. 2 is lowered over the top of vertical operating rod H1 on the hi-hat stand which will protrude through holes 7 and 8 that are centered in both the top and bottom plate of the box that now rests horizontally on the bearing surface at the top end of the stationary support tube H4 in FIGS. 2 & 6.

The sound box 5 in FIG. 1 is comprised of a plywood square top and bottom plate, each with center holes as noted above, held together at a uniform distance from each other with solid wood edge blocking 6 sandwiched between them on three sides forming a resonant air cavity 11 within to help amplify the sound of the four free-swinging blocks 12 that will strike the top surface of the sound box 5. One edge of the hollow sound box 5 remains open while the three solid edges each have three equally spaced sound holes 10 through them to better distribute the sound externally in those directions.

A hole centered thru the long edges of each of four rectangular wooden swing blocks 12 traverses the width of each block on which they pivot, side-by-side, on a single stationary axle rod 13. Centrally positioned on the continuous axle between the two pairs of these swing blocks is a shorter drive block 14 that couples the axle rod 13 at its midsection perpendicularly to the vertical operating rod H1 by means of a metal sleeve with a thumb-screw, called a clutch fastener H2, that fastens to drive block 14 through connector hole 9 with a retaining nut H3. The entire assembly is slid onto and secured to the operating rod H1 in FIGS. 1 & 4.

With the axle assembly positioned and secured to the operating rod H1 at a point an inch or two above and parallel to the top surface of the sound box in FIG. 5, the foot pedal (not shown) can be depressed, causing the assembly of blocks to travel downward and strike the box producing a cluster of percussive sounds. A spring (not shown) on the operating rod returns the upper assembly to its elevated position when the pedal is released. A vertical hole in the drive block slides over a guidepost 16 that keeps the upper assembly aligned and square to the sound box at all times.

All striker blocks 12 and the drive block 14 are separated from each other by nylon spacers 18 between each. All blocks and spacers are loosely retained on the length of the axle rod by a stop nut 17 on each end of the rod. While the blocks can swivel freely, the axle rod 13 remains stationary, kept from rotating by set screw 15 in drive block 14. This is necessary to limit the rotation of each swing block as described next.

Each swing block (striker) has a large access hole 19 centered thru the face exposing the axle where it passes thru the middle. At this point the axle also passes thru a secondary bushing 20 that has a threaded hole and a long screw post 21 thru the sleeve in FIG. 3A. This screw post is perpendicular to the axle but can be adjusted rotationally and tightened against the axle at a variable angle which will limit the rotation of the swing block when the post hits the edge of the access hole thereby limiting the downward travel of the end of the block which has a counterweight screw 22 to bias the swing downward. This adjustable stop and balance configuration allows the array of blocks to strike the soundboard in a staggered sequence with one end of each block making contact slightly before their centers and their entire lengths simultaneously strike the box as the assembly closes down completely in full parallel contact between blocks and box. The slight staggering of each cluster of strikes lends a unique and desirable hand-clapping character to the other salient sound properties such as tone and timber determined by the mass and volumes of wood and air inherent in the materials and construction of the sound box.

1-3. (canceled)

4. A rhythmical sound-producing percussion instrument used by musicians and others comprising a plurality of wooden or equivalent rectangular blocks arrayed side-by-side and parallel- each of said blocks independently pivot-able on a common axle rod running transversely through the widths at the centers of said blocks; a wooden or equivalent sound box located in proximity and held stationary relative to said axle rod of blocks whereupon one or both ends of each block can simultaneously or sequentially come into contact with said sound box; and an operating rod perpendicularly affixed on one end to said axle rod of the array of blocks and the other end passing through guide holes aligned in two sides of said sound box wherein contact or separation between said array of blocks and said sound box corresponds to the position of the free end of the operating rod when manually reciprocated by the human operator.

5. The instrument recited in claim 4, wherein the operating rod embodies a spring-biased push-pull vertical rod partially enclosed by a floor-based stationary sleeve and is connected at the upper end to the midpoint of the horizontal axle rod of said array of blocks and at the lower end to a floor-based foot pedal pivoted for actuation of the operating rod for contacting or separating said array of blocks with said sound box mounted on top of said sleeve.

6. The instrument recited in claim 5, wherein a solid wooden or equivalent sounding board is substituted for said sound box.

7. The instrument recited in claim 5, wherein a spacer bushing encompasses the axle rod between each pair of adjacent pivoting blocks in said array all retained in line by cap nuts on either end of the axle rod.

8. The instrument recited in claim 7, wherein a protruding set screw on a lockable bushing on a fixed axle rod extends as a stop post through an opening in the face of each pivoting block of the array and limits said block to a variable degree of rotation biased by a counterweight in one end of said block whereby the space between the weighted end of each block at rest and the sound box is pre-set in the configurable array.

9. A rhythmical sound-producing contrivance which comprises a plurality of rectangular wooden or equivalent swiveling blocks in side-by-side array laterally transversed by a horizontal fixed axle rod through the centers of said blocks wherein each block has an access hole perpendicular to the axis of rotation from which a protruding set screw extending radially from an adjustable bushing encompassing said axle rod at each intersection of said blocks is set for an individually limited angle of rotation of each swiveling block; a counterweight in one end of each of said swiveling blocks; a central drive block perpendicularly coupling a vertical push-pull operating rod to the midpoint of said axle rod of said array of swiveling blocks; a set screw affixing said axle rod to said drive block; spacer bushings retained on said axle rod between all blocks in said array; cap nut retainers on either end of said axle rod; a wooden or equivalent sound box positioned in proximity below said array of blocks with top surface of said sound box parallel to said axle rod whereat said array of blocks contact or separate from surface of said sound box; a guide post protruding vertically from top of said sound box aligned and engaged with guide hole in said drive block; a spring-biased vertical operating rod partially encased by a floor-based stationary sleeve on which said sound box is mounted; a foot-pedal hinged on one end to said floor base and linked to said operating rod on the other end; and a coiled compression spring in-line between bottom of said operating rod and said floor base.
